(19) United States
(12) Patent Application Publication
(10) Pub. No.: US 2010/0114851 A1
(43) Pub. Date: May 6, 2010

(54) SEARCHING FOR USER INTERFACE CONTROLS

(76) Inventor: Gregg Wernecke, La Crescent, MN (US)

Correspondence Address: SAP AG, 3410 HILLVIEW AVENUE, PALO ALTO, CA, 94304, US

(21) Appl. No.: 12/265,741

(22) Filed: Nov. 6, 2008

(51) Int. Cl. G06F 17/30; G06F 7/00

(52) U.S. Cl. 707/705; 707/E17.014

(57) ABSTRACT

Described are methods and systems related to a search engine for searching user interface controls in applications. A search query including search keywords is received from a user. A search is executed based upon the search query, to retrieve the user interface controls that match the search query. The retrieved user interface controls are formatted and displayed to the user, for example, as a user interface control grid. The retrieved user interface controls in the user interface control grid include a data entry field operable to accept user input data.

### FIELD OF THE INVENTION

Embodiments of the invention generally relate to the field of searching for controls, and more specifically to various methods and systems for searching for user interface controls in one or more applications.

### BACKGROUND OF THE INVENTION

Software applications generally include programs, forms, documents, players etc and their respective user interface controls on dialogs. Many times, similar controls will appear repeatedly on separate dialogs. Manually searching for desired controls in such large applications is laborious. Manual searching involves analyzing each part of the application to find the desired control. When a manual search is performed for a certain control across multiple application dialogs, each of the screens has to be navigated to and analyzed separately. Such tasks consume a lot of the user's time. Also, to assign data to single or repetitive controls of an application, one has to search for the controls in the application, and assign data to each of the controls on their respective screens. A lot of wading between multiple screens is involved while assigning data to each of the controls that may appear in various areas of the application. This may cause confusion to the user when a large number of controls existing on separate screens are involved. There is a need for a system to search and retrieve the controls from the application and assign and /or modify data respectively.

### SUMMARY OF THE INVENTION

Described are methods and systems related to a search engine for searching user interface controls in applications. A search query including search keywords is received from a user. A search is executed based upon the search query, to retrieve the user interface controls that match the search query. The retrieved user interface controls are formatted and displayed to the user, for example, rendered as a user interface control grid. The retrieved user interface controls include a data entry field operable to accept user input data.

These and other benefits and features of embodiments of the invention will be apparent upon consideration of the following description of embodiments thereof, presented in connection with the following drawings in which like reference numerals are used to identify like elements throughout.

### BRIEF DESCRIPTION OF THE DRAWINGS

The claims set forth the embodiments of the invention with particularity. The embodiments of the invention, together with its advantages, may be best understood from the following detailed description taken in conjunction with the accompanying drawings. The invention is illustrated by way of example and not by way of limitation in the figures of the accompanying drawings. It should be noted that references to “an” or “one” embodiment in this disclosure are not necessarily to the same embodiment, and such references mean at least one.

FIG. 1 is a functional block diagram of a system for searching user interface controls in an application according to an embodiment of the invention.

FIG. 2 is an example screen display of a user interface for searching user interface controls in an application according to an embodiment of the invention.

FIG. 3 is a flow diagram of a process for searching user interface controls in an application according to an embodiment of the invention.

FIG. 4 is a block diagram of a system for searching user interface controls in an application according to an embodiment of the invention.

### DETAILED DESCRIPTION

Described are methods and systems related to a search engine for searching user interface controls in applications. A search query including search keywords is received from a user. A search is executed based upon the search query, to retrieve the user interface controls that match the search query. The retrieved user interface controls are formatted and displayed to the user. The retrieved user interface controls include a data entry field operable to accept user input data that otherwise would have been entered via an application that it is associated with.

In an embodiment, the retrieved user interface controls accept user input data through the corresponding data entry fields, and perform functions related to the user input data and the corresponding data entry fields. Multiple retrieved user interface controls may be selected and modified at a single instance. The search may be performed in a single application, across multiple screens, a single application, across multiple applications, a single form, across multiple forms, an operating system, and the like. The method also allows a user to modify the existing value of the user interface controls.

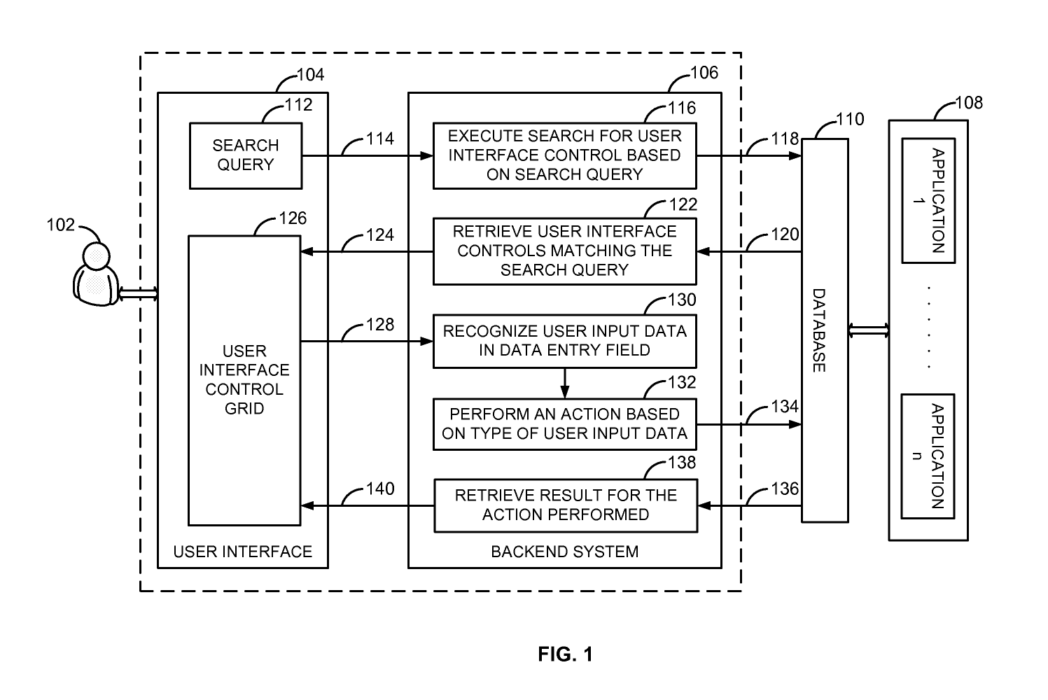

FIG. 1 is a functional block diagram of a system for searching user interface controls in an application according to an embodiment of the invention. User interface 104 illustrates exemplary methods and systems of the present invention. User interface 104 is generally a means for providing an interface for a user to interact with a machine. The behavior of user interface 104 may be governed by computer-executable instructions that are executed when user 102 interacts with user interface 104. User interface 104 refers to any information presented to user 102 by a program, and portrays different types of relationships between user interface (UI) controls that user 102 employs to control the program. A UI control generally includes a UI label that is used to identify the UI control, and a data entry field that accepts a user input data depending on a type of UI controls. Types of UI controls include animation control, pop-up menu, progress bar control, check box, push button, radio button, scrollbar, drop down menu, tooltip, and the like. For example, a UI control to open a new file may include a UI label “file”, which may accept a “mouse click” as a user input data, and the corresponding type of UI control may be a push button type.

Backend system 106 generally helps user 102 to implement a search to find one or more desired UI controls in application 108. Application 108 is a collection of one or more programs that provide instructions and corresponding tools to user 102 to accomplish a task. Application 108 includes a set of UI controls to control the function of a program. In an embodiment, search query 112 is provided by user 102 through user interface 104 to backend system 106. Search query 112 may include a collection of search keywords that are related to the UI control being searched for in the one or more UI controls of application 108. For instance, the search keyword may be a part of a label describing the corresponding UI control, a part of a meaning of the label describing the corresponding UI control, or other such information capable of identifying the UI control. For example, if “telephone number” is the label of a UI control, the search keywords including “number”, “telephone”, “phone”, “cell”, “contact” and the like may refer to the UI control with the label “telephone number”. Search query 112 may also include one or more wildcard characters, operators, etc. A wildcard character is a character that represents one or more other characters. For instance, an asterisk (“*”) may be used to specify zero or more alphanumeric characters. A search term including “tele*” may yield search results containing “telephone”, “television”, “telesales” etc. An operator is generally used to combine multiple search terms. For instance, using an “AND” operator in between two terms may yield search results containing both the search terms. For example, a search term including “contact AND address” may yield search result containing both the search terms.

At 114, search query 112 is provided to backend system 106 to execute a search 116 for one or more user interface controls based on the received search query. Executing a search based on a search query includes searching for UI controls whose information matches the search keywords of search query 112. In an embodiment, UI controls are indexed with corresponding tags. Tags generally refer to any information that is used to describe a UI control. Executing a search based on the search query may involve searching for the UI controls whose tags match the search keywords of search query 112. The search for UI controls can be performed in one or more applications, an operating system, one or more forms, user interface screens and the like. The search performed may include entering one or more search keywords to narrow a search, using Boolean expressions along with search keywords, using exact match criteria along with search keywords and the like.

Application 108 is preferably in communication with database 110. Database 110 is generally a structured collection of data such as an index, for example. Thus, database 110 stores information related to the UI controls of application 108. In an embodiment, the UI controls are indexed with the corresponding tags, and are stored in database 110. The indexing of UI controls with corresponding tags may be updated at regular intervals to include any new information about the UI control. At 120, backend system 106 retrieves 122 the UI controls that match search query 112. The UI controls that match search query 112 includes UI controls whose labels match the search query, UI controls whose tags include information that match the search query, forms or applications that refer to the search query, and the like. Tags may also include information about the UI controls that are related to one another. Thus, during execution of the search, the related UI controls may also be retrieved. The retrieved UI controls are rendered 124 as user interface control grid 126 on user interface 104. User interface control grid 126 may include a list of the retrieved UI controls that are formatted and displayed by a user, a graphical representation of the retrieved UI controls, a table of the retrieved UI controls, and the like.

User interface control grid 126 is generally a listing of search results retrieved by executing a search for search query 112. User interface control grid 126 is a table that lists the retrieved UI controls. User interface control grid 126 may also include a link to the retrieved UI controls, and a short description of the retrieved UI controls, and any such information about the UI controls. User interface control grid 126 may include a collection of retrieved UI controls that may exist in various levels of an application, and rendering such retrieved UI controls may avoid navigation between various screens of application 108 in which the corresponding UI controls exist. The retrieved UI controls are preferably accessible to user 102 and capable of accepting user input that otherwise would have been entered via the applications.

Rendering the UI controls as user interface control grid includes populating the retrieved UI controls. Populating UI controls may include presenting the UI controls in the form of hyperlinks that generally indicate a reference in the application. The hyperlink can be considered as a navigation element that allows navigating from a present portion of a document to a portion of the document represented by the hyperlink. UI labels of the retrieved UI controls act as identifiers for the UI control. Data entry fields of each of the retrieved UI controls denote the function associated with the UI control. The functions associated with the retrieved UI controls include accepting user input data as text, numbers, a mouse click, a mouse hover, a drop down selection, a radio button selection, a check box selection and the like.

In an embodiment, the retrieved UI controls may be ranked in the order of relevancy corresponding to the search query 112. The retrieved UI controls may also be ranked based on the most relevant UI control, in a collection of related UI controls. For example, if the search term is “member”, the retrieved UI controls may include “membership number”, “membership type”, “member name”, “member address” etc., the retrieved UI controls are be ranked starting from: “member name”, “member address”, “membership number” and “membership type”. Multiple retrieved UI controls in user interface control grid 126 may accept a single user input data at a given instance. Multiple retrieved user interface controls may be selected and modified at a single instance. The retrieved UI controls in user interface control grid 126 may also be sorted or grouped based upon properties of the UI controls, including the data entry field, the part of the application they exist in, a similar user input data they accept, a similar type of action they perform, and the like. For example, user interface control grid 126 may include “telephone number”, “address”, “date of birth”, “name”, “gender”, “state”, “city”, and “country” as retrieved UI controls. The retrieved UI controls may be sorted based upon the data entry field, as: “name”, “address”, “state”, “country”, “city”, accepting text as data input, “telephone number”, “date of birth” accepting numbers as data input, and “gender” accepting radio selection as data input. The retrieved UI controls may be grouped based upon the part of the application they exist in, for example: “country”, “state”, “city” existing one after another. The UI controls in user interface control grid 126 may also be indexed. The retrieved UI controls may also lead to a location where the corresponding application exists.

User 102 may perform an action of providing user input data on one or more of the retrieved UI controls. The action performed may include selecting one or more of the retrieved UI controls and setting the selected UI controls to a certain value, selecting one or more of the retrieved UI controls and performing a data entry in the data entry field, selecting one of the retrieved UI controls to be guided to a part of the application where the retrieved UI control exists, and the like. The user input data provided by user 102 may also be a modification of an already existing value of the UI control. At 128, the user action performed on the retrieved UI control is communicated to backend system 106. Backend system 106 recognizes 130 the user input data in the data entry field of the retrieved UI control, and performs an action 132 based on the type of user input data and the function associated with the retrieved UI control. The action performed 132 by backend system 106 may further be communicated to application 108. Any result associated with the action performed is communicated 136 to backend system 106. Backend system 106 retrieves 138 the result for the action performed and renders 140 the result on user interface control grid 126.

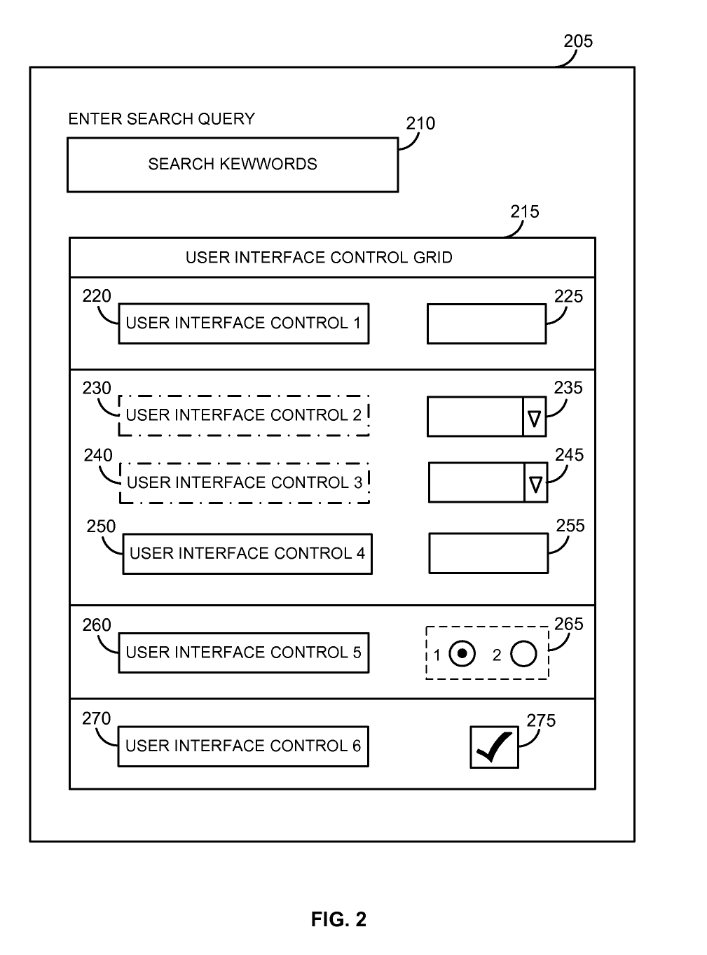

FIG. 2 is an example screen display of a user interface for searching user interface controls in an application according to an embodiment of the inventions. User interface 205 provides an interface for the user to interact with a machine. User interface 205 displays a search page, including a search query element 210 that accepts search keywords. The search keywords are generally related to any information of one or more user interface controls in the application, including the user interface label, tag information that is used to describe the user interface control, or other such information capable of identifying the user interface control. A search is executed in a backend system, based upon the search query. Executing a search includes searching for user interface controls whose information matches the search keywords of the search query. The search may be executed in a memory unit. In an embodiment, the search is executed in a database of the application. User interface controls matching the search query are retrieved from the database of the application. The retrieved user interface (UI) controls are rendered as user interface control grid 215. User interface control grid 215 is preferably a table that lists the retrieved UI controls (e.g. 220, 230, 240, 250, 260, and 270). The retrieved UI controls include corresponding data entry fields (e.g. 225, 235, 245, 255, 265, and 275) that are operable to accept user input data based upon the type of user interface control and corresponding type of data entry field, and perform corresponding operations.

For example, a search is performed using search query “member” in search query element 210. User interface control grid 215 that represents the retrieved UI controls may include “member name”, “member type”, “membership status” and “receive membership alerts” as four user interface controls (e.g. 220, 230, 260 and 270) along with the respective data entry fields (e.g. 225, 235, 265 and 275). Data entry field 225 of user interface control 220 is of the type “text box”, and hence accepts values in the form of text. Data entry field 235 of user interface control 230 is of the type “drop down”, and hence accepts one of the values listed in the drop down menu. Data entry field 265 of user interface control 260 is of the type “radio button”, and hence accepts a selection of one of the radio buttons as values. Data entry field 275 of user interface control 270 is of the type “check box”, and hence accepts values in the form of a check.

In an embodiment, the retrieved UI controls may be related to one another. For example, a set of UI controls may exist in a hierarchical form in the application, and the search query may retrieve UI controls that may refer to one of the set of UI controls in the application. For instance, consider three UI controls 230, 240 and 250 representing “Country”, “State” and “City” respectively that are related to one another. If a search is performed for a UI control using the search query “City” in search query element 210, all three UI controls 230, 240, 250 that represent “Country”, “State” and “City” would be listed in user interface control grid 215. User may enter user input data to all three UI controls from user interface control grid 215.

In another example, if values have already been assigned to the related UI controls 230 and 240 in the hierarchy, then a value may be set to the retrieved UI control 250 depending upon the value of the related UI controls 230 and 240. For instance, if the UI controls 230 and 240 representing “Country” and “State” have values “Canada” and “British Columbia” respectively in the data entry fields 235 and 240, the value of the retrieved UI control 250 in the data entry field 255 may only be set to a city in British Columbia such as Suffolk, for instance. The related UI controls may be excluded or hidden based upon a user action. The related UI controls may also be filtered based upon a user action, to render relevant UI controls in user interface control grid 215.

In an embodiment, when the retrieved UI controls include a UI control that may exist in a hierarchical form, a dynamic screen may be created, that includes a list of related UI controls for a retrieved UI control. Thus user 102 is not deviated from the relevant search result he may be interested in. Another example may include an instance when the retrieved UI controls accept user input data only after the related UI controls in the hierarchy have accepted values. Thus, existing data assigned to UI controls in the application can also be dynamically modified. In another embodiment, if a same user input data has to be assigned to more than one retrieved UI control, the retrieved UI controls are grouped such that the user input data assigned to one of the retrieved UI controls would reflect in the other similar retrieved UI controls.

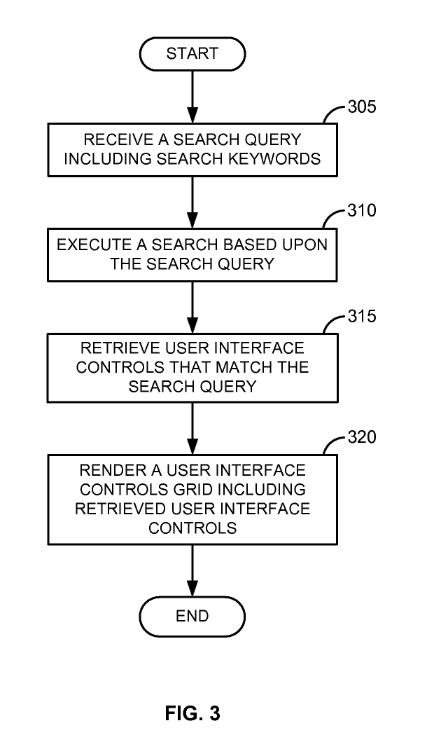

FIG. 3 is a flow diagram of a process for searching user interface controls in an application according to an embodiment of the invention. In process block 305, a search query including one or more search keywords is received. The search query preferably includes a collection of search keywords that is related to any information of one or more user interface controls in the application including the user interface label, tag information that is used to describe the user interface control, or other such information capable of identifying the user interface control. In process block 310, a search is executed, based upon the search query. Executing a search based upon the search query includes searching for user interface controls whose information matches the search keywords of the search query. The search may be executed in a database of an application. In process block 315, the user interface controls matching the search query are retrieved from the database of the application. In process block 320, the retrieved user interface controls are rendered as a user interface control grid. The user interface control grid is a table that lists the retrieved user interface controls. The retrieved user interface controls include corresponding data entry fields that are operable to accept user input data based upon the type of user interface control and corresponding type of data entry field, and perform corresponding operations. Without the user interface control grid, each of the user interface control has to be searched in the database and user input data has to be individually entered to each of the user interface control via one of the applications.

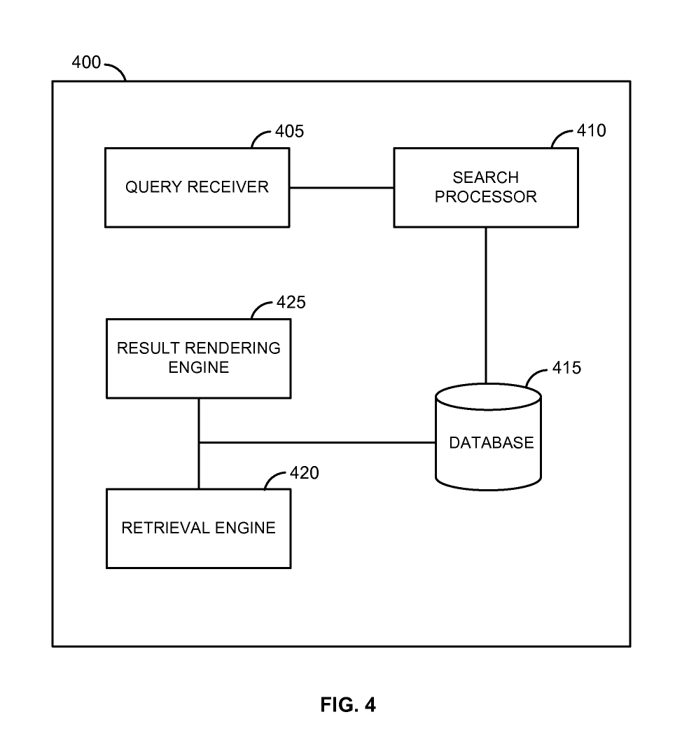

FIG. 4 is a block diagram of a system for searching user interface controls in an application according to an embodiment of the invention. System 400 includes query receiver 405, search processor 410, database 415, retrieval engine 420 and result rendering engine 425. According to an embodiment, query receiver 405 is in communication with search processor 410. Search processor 410 is in communication with database 415. Database 415 is in communication with retrieval engine 420 and result rendering engine 425.

System 400 allows a user to search for one or more user interface controls in an application. Query receiver 405 receives a search query including search keywords from the user. The search query includes a collection of search keywords that is related to a user interface label of one or more user interface controls in the application. Search processor 410 executes a search based upon the search query. The search query preferably includes a collection of search keywords that is related to any information of one or more user interface controls in the application, including the user interface label, tag information that is used to describe the user interface control, or other such information capable of identifying the user interface control. Executing a search based upon the search query includes searching for user interface controls whose information match the search keywords of the search query. The search may be executed in a database of an application. Retrieval engine 420 retrieves the user interface controls that match the search query from the database of the application. Result rendering engine 425 renders the retrieved user interface controls as a user interface control grid.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, or any other type of machine-readable media suitable for tangibly storing electronic instructions. The machine readable medium can provide the instructions stored therein to a computer system comprising a processor capable of reading and executing the instructions to implement the method steps described herein.

It should be appreciated that reference throughout this specification to one embodiment or an embodiment means that a particular feature, structure or characteristic described in connection with the embodiment is included in at least one embodiment of the present invention. These references are not necessarily all referring to the same embodiment. Furthermore, the particular features, structures or characteristics may be combined as suitable in one or more embodiments of the invention.

Throughout the foregoing description, for the purposes of explanation, numerous specific details were set forth in order to provide a thorough understanding of the invention. It will be apparent, however, to one skilled in the art that the invention may be practiced without some of these specific details. The detailed description as set forth above includes descriptions of method steps. However, one skilled in the art will understand that the order of the steps set forth above is meant for the purposes of illustration only and the claimed invention is not meant to be limited only to the specific order in which the steps are set forth. Accordingly, the scope and spirit of the invention should be judged in terms of the claims which follow.

1. A computer implemented method for searching one or more user interface controls operable for providing user input to one or more applications, the method comprising:
receiving a search query, the search query having one or more search keywords;
executing a search based upon the search query to retrieve one or more user interface controls that match the search query; and
rendering a user interface control grid comprising one or more of the retrieved user interface controls, the user interface control grid being separate from the one or more applications and the retrieved user interface controls including at least one data entry field operable to accept user input data that otherwise would have been entered via one of the one or more applications.

2. The computer implemented method of claim 1, wherein the one or more user interface controls are indexed with corresponding tags.

3. The computer implemented method of claim 2, wherein the tags comprise of information that is used to describe the one or more user interface controls.

4. The computer implemented method of claim 1, wherein the one or more applications are in communication with a database to store the one or more user interface controls.

5. The computer implemented method of claim 4, wherein the database stores an association of the one or more user interface controls with the corresponding tags.

6. The computer implemented method of claim 1, wherein executing the search comprises searching a database for the one or more user interface controls that match the search query.

7. The computer implemented method of claim 1, wherein rendering the user interface control grid comprises populating the one or more retrieved user interface controls.

8. The computer implemented method of claim 1, wherein the one or more retrieved user interface controls comprise one or more data entry field types to receive one or more types of user input data.

9. The computer implemented method of claim 1, wherein the user interface controls grid further comprises one or more retrieved user interface controls that are related to one another.

10. The computer implemented method of claim 9, wherein the related user interface controls may exist in a hierarchy.

11. The computer implemented method of claim 10, wherein the one or more user interface controls accept user input data based upon a value of the related user interface controls.

12. The computer implemented method of claim 1, wherein the retrieved user interface controls are ranked based upon a relevancy corresponding to the search query.

13. The computer implemented method of claim 1, wherein the one or more retrieved user interface controls are operable to accept user input data at a given instance.

14. The computer implemented method of claim 1, wherein rendering the user interface control grid comprises sorting the one or more retrieved user interface controls based upon the corresponding data entry field.

15. The computer implemented method of claim 1, wherein rendering the user interface control grid comprises grouping the one or more retrieved user interface controls based upon properties of the one or more retrieved UI controls.

16. The computer implemented method of claim 1, wherein the one or more retrieved user interface controls are operable to be directed to a location in which a corresponding application exists.

17. The computer implemented method of claim 1, wherein the one or more user interface controls are retrieved based upon one or more tags associated with the one or more user interface controls that match the search query.

18. A system for searching one or more user interface controls in one or more applications, the method comprising:
a query receiver for receiving a search query from a user, the search query having one or more search keywords;
a search processor in communication with the search interface, for executing a search based upon the search query;
a retrieval engine in communication with the search processor for retrieving one or more user interface controls that match the search query; and
a result rendering engine in communication with the retrieval engine to render a user interface grid, the user interface grid having the one or more retrieved user interface controls, wherein each of the retrieved user interface controls include a data entry field operable to accept a user input data.

19. The system of claim 18, wherein the search processor executes the search in a database.

20. An article of manufacture, comprising: a tangible storage medium comprising machine readable instructions which when executed by a machine causes the machine to perform a method for searching one or more user interface controls operable for providing user input to one or more applications, the method comprising
receiving a search query from a user, the search query having one or more search keywords;
executing a search based upon the search query to retrieve one or more user interface controls that match the search query; and
rendering a user interface control grid comprising the one or more retrieved user interface controls, the user interface control grid being separate from the one or more applications wherein each of the retrieved user interface controls includes a data entry field operable to accept a user input data that otherwise would have been entered via one of the one or more applications.
